(19) United States
(12) Patent Application Publication
(10) Pub. No.: US 2018/0366694 A1
(43) Pub. Date: Dec. 20, 2018

(54) CAP ASSEMBLY FOR A POWER BATTERY, POWER BATTERY AND BATTERY MODULE

(71) Applicant: Contemporary Amperex Technology Co., Limited, Ningde City (CN)

(72) Inventors: Zhixian LIU, Ningde City (CN); Peng WANG, Ningde City (CN); Zhijun GUO, Ningde City (CN); Shoujun HUANG, Ningde City (CN); Chengyou XING, Ningde City (CN)

(73) Assignee: Contemporary Amperex Technology Co., Limited, Ningde City (CN)

(21) Appl. No.: 15/873,512

(22) Filed: Jan. 17, 2018

(30) Foreign Application Priority Data
Jun. 20, 2017 (CN) 201710469888.7

(51) Int. Cl. H01M 2/04; H01M 2/08; H01M 2/06; H01M 2/30; H01M 2/02; H01M 2/12

(52) U.S. Cl. CPC H01M 2/043; H01M 2/08; H01M 2/0456; H01M 2/06; H01M 2220/20; H01M 2/021; H01M 2/12; H01M 2/0482; H01M 2200/20; H01M 2/305

(57) ABSTRACT

The present disclosure provides a cap assembly for a power battery, a power battery and a battery module. The cap assembly for a power battery includes a cap plate; a first electrode terminal and a second electrode terminal. The first electrode terminal includes a first pole and a first terminal board. The first terminal board includes a first connecting board and a first conductive board. The first conductive board exposes from a side of the first connecting board away from the cap plate. The first conductive board is connected with the first pole and the first connecting board. The second electrode terminal is disposed at the other end of the cap plate in length direction and insulated from the first electrode terminal.

### CROSS REFERENCE TO RELATED APPLICATION

The present application is based upon and claims the benefits of Chinese Patent Application No. 201710469888.7 filed on Jun. 20, 2017, the entire contents of which are incorporated herein by reference.

### FIELD

The present disclosure relates to the technical field of energy storage devices, and in particular, to a cap assembly for a power battery, a power battery and a battery module.

### BACKGROUND

Currently, a battery module with a cascaded structure uses a connecting plate to connect a positive electrode terminal and a negative electrode terminal of a battery. The connecting plate is connected with the positive electrode terminal and the negative electrode terminal by laser welding to ensure good conductivity and reliability of connection. Currently, the negative electrode terminal of the battery is usually made of copper, and the positive electrode terminal of the battery is usually made of aluminum. In order to realize the laser welding and ensure welding strength, the connecting plate welded with the negative electrode terminal is required to be made of copper and the connecting plate welded with the positive electrode terminal is required to be made of aluminum. However, it is difficult for the connecting plate which is made of a single material to well weld with the positive electrode terminal and the negative electrode terminal which are made of two different materials at the same time. Therefore, copper-aluminum conversion is required for the positive electrode terminal or the negative electrode terminal in order to realize good welding between the connecting plate which is made of a single material and the positive electrode terminal as well as the negative electrode terminal at the same time.

As shown in FIG. 5, the negative electrode terminal 100′ includes a terminal board (copper-aluminum conversion is performed on the terminal board) and a copper pole 110′. The terminal board includes an aluminum connecting board 130′ and a copper conductive board 120′ exposed from the aluminum connecting board 130′. When two batteries are connected in series by the connecting plate 801′, since the copper conductive board 120′ is exposed from the aluminum connecting board 130′, the copper conductive board 120′ is required to be staggered when the aluminum connecting plate 801′ is welded with the terminal board. Usually, the aluminum connecting board 130′ extends toward the positive electrode terminal 200′ and is welded with the connecting plate 801′. Thus, the connecting plate 801′ needs to be designed into a “Z” shape or other shape. When the connecting plate 801′ is formed in a “Z” shape, utilization of raw material will be low, the material of the connecting plate 801′ is wasted, and the Z-shaped connecting plate 801′ cannot be applied to batteries which are connected in parallel. At the same time, since the aluminum connecting board 130′ extends toward the positive electrode terminal 200′, a space for disposing a module harness board (the module harness board is used to collect voltage, temperature and the like and usually located between the positive electrode terminal 200′ and the negative electrode terminal 100′). In related art, there is another approach that the connecting plate 801′ covers the copper conductive board 120′ and is welded with the aluminum connecting board 130′ on both sides of the copper conductive board 120′. The aluminum connecting board 130′ at a side close to the positive electrode terminal 200′ is also required to be long in order to ensure a sufficient welding area.

### SUMMARY

In view of the related arts, a cap assembly for a power battery, a power battery and a battery module are provided in embodiments of the present disclosure.

According to a first aspect of the embodiments of the present disclosure, there is provided a cap assembly for a power battery. The cap assembly includes a cap plate; a first electrode terminal disposed at an end of the cap plate in length direction, wherein the first electrode terminal includes a first pole and a first terminal board, the first terminal board is located at a side of the cap plate in height direction and includes a first connecting board and a first conductive board, the first conductive board exposes from a side of the first connecting board away from the cap plate, and the first conductive board is connected with the first pole and the first connecting board; and a second electrode terminal disposed at the other end of the cap plate in length direction, wherein the first connecting board has a first extension portion extending in a direction away from the second electrode terminal and a second extension portion extending in a direction approaching the second electrode terminal, the first conductive board is located at a side of the first extension portion close to the second electrode terminal; length of the first extension portion is greater than that of the second extension portion in length direction, and wherein the first pole and the first conductive board are made of a same material, and the first extension portion is made of a different material.

Optionally, the cap assembly further includes: a transforming plate connected to the cap plate and opposite to the first extension portion, wherein when gas pressure inside the power battery reaches a threshold, the transforming plate is deformed and in contact with the first extension portion so as to cause electrical connection between the first electrode terminal and the second electrode terminal.

Optionally, the second electrode terminal is electrically connected to the cap plate, and the first electrode terminal is insulated from the cap plate.

Optionally, the first pole and the first conductive board are made of copper or copper alloy, and the first extension portion is made of aluminum or aluminum alloy.

Optionally, the first extension portion and the second electrode terminal are made of a same material.

Optionally, an opening is provided on a side of the first connecting board away from the cap plate, and the first conductive board is embedded in the opening.

Optionally, the opening is a groove that does not penetrate through the first connecting board in height direction, or the opening is a through hole that penetrates through the first connecting board in height direction.

Optionally, the groove is located between the first extension portion and the second extension portion in length direction.

Optionally, the first pole passes through the cap plate, the bottom wall of the groove, and the first conductive board, and the first conductive board surrounds periphery of the first pole.

Optionally, the first pole is fixedly connected with the first connecting board by riveting.

Optionally, the first pole and the first conductive board are connected by laser welding.

Optionally, when the opening is a groove that does not penetrate through the first connecting board in height direction, the first conductive board extends in width direction and penetrates through the first connecting board.

Optionally, the second electrode terminal includes a second pole and a second terminal board, wherein the second pole passes through the cap plate and is connected to the second terminal board, and the second terminal board is located at a side of the cap plate away from the first electrode terminal.

Optionally, projection length of the transforming plate projected in thickness direction is greater than length of the second extension portion.

According to a second aspect of the embodiments of the present disclosure, there is provided a power battery including: an electrode assembly; a shell accommodating the electrode assembly; the cap assembly for the power battery which is used to close opening of the shell.

According to a third aspect of the embodiments of the present disclosure, there is also provided a battery module including: two or more the power batteries; and a connecting plate which is made of a same material as the first extension portion, wherein the connecting plate is welded to the first extension portion of one of the power batteries.

Optionally, the connecting plate extends in width direction and connects with the second electrode terminal of another one of the power batteries.

### BRIEF DESCRIPTION OF THE DRAWINGS

The present disclosure may be better understood from the following descriptions of specific embodiments of the present disclosure by taken in conjunction with the accompanying drawings, in which:

Other features, objects, and advantages of the present disclosure will become more apparent by reading the following detailed descriptions of non-limiting embodiments with reference to the accompanying drawings, in which a same or similar reference signs denote a same or similar features.

FIG. 1 is a schematic structure diagram of a cap assembly for a power battery according to an embodiment of the present disclosure;

FIG. 2 is a schematic structure diagram of a power battery according to an embodiment of the present disclosure;

FIG. 3 is a schematic diagram of appearance of a power battery according to an embodiment of the present disclosure;

FIG. 4 is a schematic structure diagram of a battery module according to an embodiment of the present disclosure;

FIG. 5 is a schematic structure diagram of a battery module in a contrast embodiment of prior art;

FIG. 6 is an enlarged schematic diagram of a portion of the structure in FIG. 1.

### REFERENCE LABELS IN THE FIGURES

100—First electrode terminal
110—First pole;
120—First conductive board;
130—First connecting board;
131—First extension portion;
132—Second extension portion,
200—Second electrode terminal;
210—Second pole;
230—Second terminal board;
300—Transforming plate;
500—Cap plate;
600—Cap assembly;
700—Electrode assembly;
800—Power battery;
801—Connecting plate;
100′—Negative terminal;
110′—Copper pole;
120′—Copper conductive board;
130′—Aluminum connecting board;
200′—Positive electrode terminal;
801′—Connecting plate.

### DETAILED DESCRIPTION

Features of various aspects and exemplary embodiments of embodiments of the present disclosure will be described in detail below. In the following detailed description, many specific details are disclosed to provide a thorough understanding of embodiments of the present disclosure. However, it is apparent to a person skilled in the art that embodiments of the present disclosure may be practiced without some of these specific details. The following descriptions of embodiments are merely to provide a better understanding of embodiments of the present disclosure through illustrating examples of embodiments of the present disclosure. Embodiments of the present disclosure is by no means limited to any specific configuration and algorithm disclosed below, but rather covering any modification, substitution, and improvement of elements, components, and algorithms without departing from the spirit of embodiments of the present disclosure. In the appended drawings and the following descriptions, well-known structures and techniques are not illustrated to avoid unnecessarily obscuring embodiments of the present disclosure.

Exemplary embodiments will now be described more fully with reference to the accompanying drawings. However, the exemplary embodiments may be embodied in many forms and should not be construed as limited to the embodiments set forth herein. Rather, these embodiments are provided so that the present disclosure will be more thorough and complete, and will fully convey the concepts of the exemplary embodiments to those skilled in the art. In the drawings, thickness of regions and layers may be exaggerated for clarity. A same reference numerals in the drawings denote a same or similar structures, and thus detailed description thereof will be omitted.

Furthermore, the features, structures, or characteristics described herein may be combined in one or more embodiments in any suitable manner. In the following description, numerous specific details are given to provide a thorough understanding of embodiments of the disclosure. However, those skilled in the art will recognize that the aspects of the disclosure may be practiced without one or more of the specific details or that other methods, components, materials, etc. may be employed. In other instances, well-known structures, materials, or operations are not shown or described in detail to avoid obscuring primary technical concepts of the present disclosure.

### Contrast Embodiment

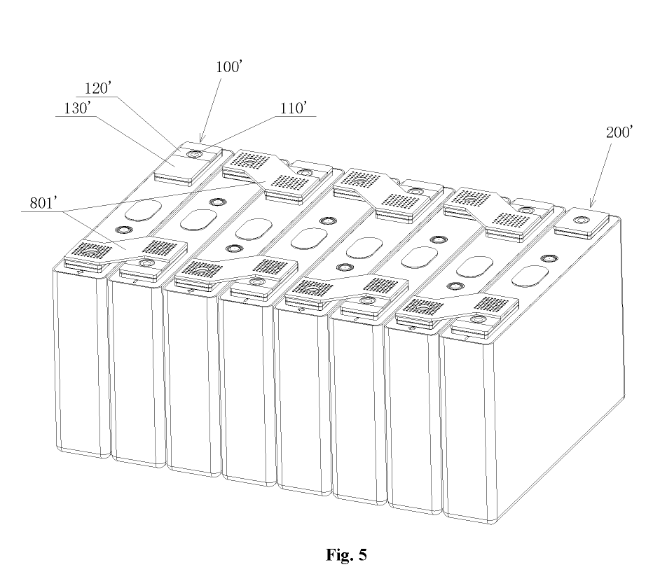

As shown in FIG. 5, which is shown as a schematic diagram of a battery module in prior art, a plurality of power batteries are connected in series, and a connecting plate 801′ with “Z” shape is used between the electrode terminals of two adjacent power batteries, The connecting plate 801′ with “Z” shape is usually an aluminum plate or an aluminum alloy plate. Compared with a connecting plate with strip shape, the connecting plate 801′ with “Z” shape needs more material and manufacturing process thereof is more complicated, thus the manufacturing cost of the connecting plate 801′ with “Z” shape is higher than that of the connecting plate with strip shape. During assembly, the connecting plate 801′ with “Z” shape cannot be used to connect multiple power batteries in parallel (because the electrode terminals with a same polarity need to be aligned in a line when the batteries are arranged in parallel). At the same time, the distance between two adjacent power batteries may change due to the expansion of the power batteries during charging and discharging of the electrode assembly. In this case, direction of force to which the connecting plate 801′ with “Z” shape is subject is different from the expansion direction of the power battery (there is a certain angle). Therefore, the welding position of the connecting plate 801′ with “Z” shape is subjected to torsion during the expansion of the power battery. There is risk of deformation or even rupture for the Z-shaped connecting plate. As a result, firmness of the Z-shaped connecting plate is reduced, and thus connection and service life of the power batteries will be affected. Furthermore, area of the connection between the connecting plate 801′ with “Z” shape and the electrode terminal may be decreased due to the expansion of the power battery. As a result, the resistance of the connection may be increased, and thus more power may be consumed and more heat may be generated, which also affects life of the power battery.

### Embodiment 1 of the Present Disclosure

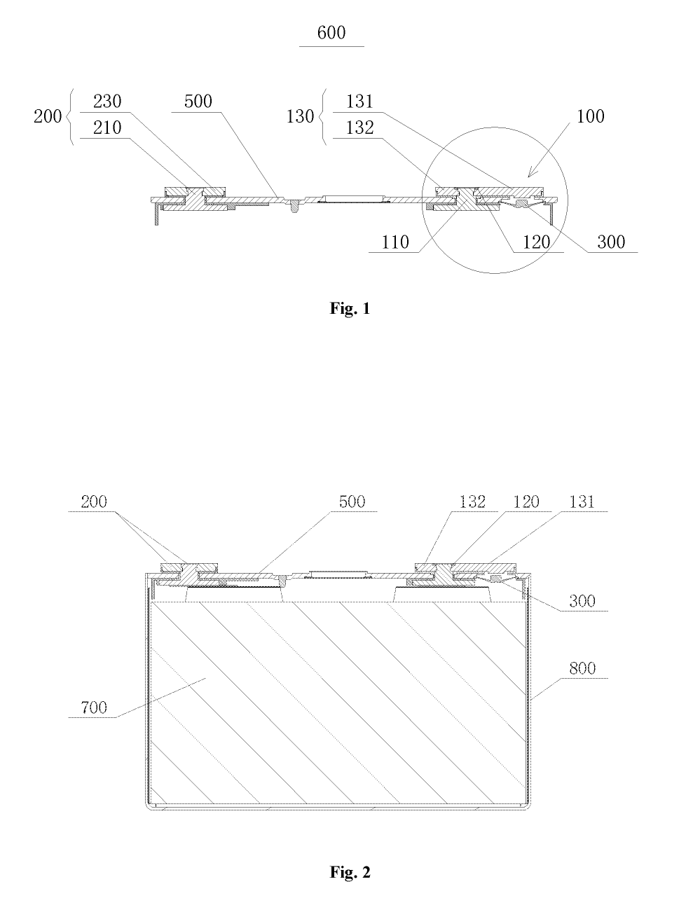

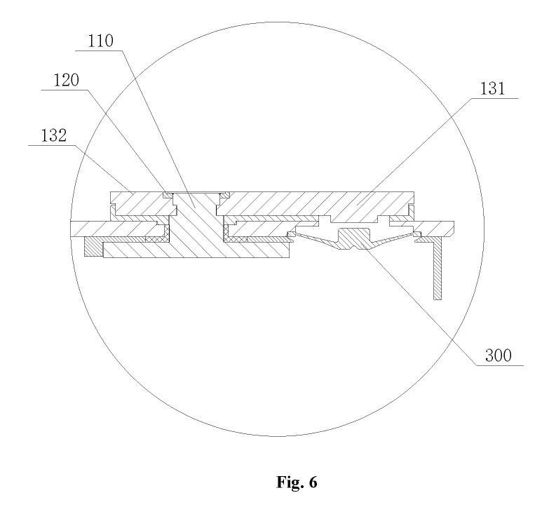

As shown in FIG. 1 and FIG. 6, according to a first aspect of the embodiments of the present disclosure, there is provided a cap assembly 700 for a power battery. The cap assembly 700 includes a cap plate 500, a first electrode terminal 100, and a second electrode terminal 200. The first electrode terminal 100 may be a positive electrode terminal, and accordingly, the second electrode terminal 200 is a negative electrode terminal. The first electrode terminal 100 may also be a negative electrode terminal, and accordingly, the second electrode terminal 200 is a positive electrode terminal.

The first electrode terminal 100 is disposed at an end of the cap plate 500 in length direction. The first electrode terminal includes a first pole 110 and a first terminal board. The first terminal board is located at a side of the cap plate 500 in height direction and includes a first connecting board 130 and a first conductive board 120. The first conductive board 120 exposes from a side of the first connecting board 130 away from the cap plate 500. The first conductive board is connected with the first pole 110 and the first connecting board 130.

The second electrode terminal 200 is disposed at the other end of the cap plate 500 in length direction and insulated with the first electrode terminal 100. The first connecting board 130 has a first extension portion 131 extending in a direction away from the second electrode terminal 200 and a second extension portion 132 extending in a direction approaching the second electrode terminal 200. The first conductive board 120 is located at a side of the first extension portion 131 close to the second electrode terminal 200. The length of the first extension portion 131, in length direction, is greater than that of the second extension portion 132. The length of the first extension portion 131 refers to the distance between the edge of the first extension portion 131 away from the second electrode terminal 200 and the edge of the first conductive board 120 away from the second electrode terminal 200. The length of the second extension portion 132 refers to the distance between the edge of the second extension portion 132 close to the second electrode terminal 200 and the edge of the first conductive board 120 close to the second electrode terminal 200. Preferably, the length of the first extension portion 131 is 2 to 100 times the length of the second extension portion 132, and further, the length of the first extension portion 131 is 5 to 20 times the length of the second extension portion 132.

In the cap assembly for the power battery provided by the embodiments of the present disclosure, structure of the first electrode terminal is optimized so that the connecting plate made of a single material can be welded well with the first electrode terminal and the second electrode terminal. In addition, when the power batteries are connected in series in thickness direction, the first extension portion and the second electrode terminal of two adjacent power batteries can be disposed in a same line without occupying the space between the first electrode terminal and the second electrode terminal. As a result, it can be avoided to use Z-shaped connecting plate and the arrangement of the module harness board will not be affected.

Optionally, the cap assembly 600 for the power battery provided in this embodiment further includes a transforming plate 300. The transforming plate 300 is connected to the cap plate 500 and opposite to the first extension portion 131. When the gas pressure inside the power battery reaches a threshold value, the transforming plate 300 is deformed and in contact with the first extension portion 131 to cause the first electrode terminal 100 to electrically connect with the second electrode terminal 200.

In the present embodiment, the transforming plate 300 is located at a side outside of the first pole 110 away from the second electrode terminal 200 to solve overcharge of the battery. Compared with the scheme where the transforming plate 300 is located at a side outside of the first pole 110 approaching the second electrode terminal 200, the transforming plate 300 being disposed outside the first pole 110 would not further occupy space for the module harness board.

When the transforming plate 300 is provided, a through hole is provided on the cap plate 500 and a groove is provided around the through hole. The transforming plate 300 includes a connecting portion, a boss, and a deformation portion located between the connecting portion and the boss. The boss is disposed at a central position of the transforming plate 300. The connecting portion is disposed at the outer peripheral edge of the deformation portion. The connecting portion is accommodated in the groove and welded to the cap plate 500 to close the through hole.

When the transforming plate 300 is projected in thickness direction, the projection length of the transforming plate 300 is greater than the length of the second extension portion 132. When the projection of the transforming plate 300 projected in thickness direction is circular, diameter of the projection of the transforming plate 300 is greater than the length of the second extension portion 132. As the transforming plate 300 is deformed by the internal gas and in turn in contact with the first extension portion 131, the acting force to the transforming plate 300 from the internal gas is proportional to the projection area of the transforming plate 300 in thickness direction, that is, the larger the projected area of the transforming plate 300 in thickness direction, the larger the acting force to the transforming plate 300 from the internal gas. In order to ensure that the transforming plate 300 may be deformed with a small internal gas pressure, the projection area of the transforming plate 300 in thickness direction is required to be as large as possible. If the transforming plate 300 is disposed to be opposite to the second extension portion 132, it is necessary that the second extension portion 132 is extended in the direction toward the second electrode terminal 200 so as to ensure a sufficient length to contact with the deformed transforming plate 300, which, however, may further occupy space for the module harness board. In this embodiment, since the length of the first extension portion 131 is greater than that of the second extension portion 132, the length of the first extension portion 131 can be utilized without further occupying space for the module harness board. In other words, compared with the configuration in which the transforming plate 300 is disposed to be opposite to the second extension portion 132, in the configuration in which the transforming plate 300 is disposed to be opposite to the first extension portion 131, the projection area of the transforming plate 300 in thickness direction may be larger to ensure that the transforming plate 300 can be deformed with a smaller internal gas pressure.

During implementation, the second electrode terminal 200 is electrically connected to the cap plate 500, and the first electrode terminal 100 is insulated from the cap plate 500 to prevent short circuit due to direct electrical connection between the first electrode terminal 100 and the second electrode terminal 200 in normal use. In order to insulate the first electrode terminal 100 and the second electrode terminal 200 from each other, a structure such as an insulating plate, an insulating sealing ring and the like may be provided between the first electrode terminal 100 and the cap plate 500.

Optionally, the first pole 110 and the first conductive board 120 are made of a same material, which is different from the material of which the first connecting board 130 is made. It should be noted that, in the present disclosure, a same material refers to a same metal matrix (for example, aluminum and aluminum alloy have a same metal matrix of aluminum), and different materials refer to different metal matrix (for example, the metal matrix of aluminum alloy is aluminum, and the metal matrix of copper alloy is copper). Specifically, the first pole 110 and the first conductive board 120 are made of is copper or copper alloy; and the first connecting board 130 is made of aluminum or aluminum alloy.

Optionally, the first connecting board 130 and the second electrode terminal 200 are made of a same material, and in use, the first connecting board 130, the second electrode terminal 200 and the connecting plate are made of a same material, so that the first connecting board 130 and the second electrode terminal 200 of two adjacent power batteries connected in series are connected through the connecting plate to facilitate welding operation. A same material in welding may provide better performance in mechanics and conductivity than different materials, and therefore, performance of the power batteries can be more stable.

Optionally, a groove is disposed at a side of the first connecting board 130 away from the cap plate 500, and the first conductive board 120 is embedded in the groove. When the first connecting board 130 is an aluminum board and the first conductive board 120 is a copper board, a combining surface is formed by welding between the first conductive board 120 and the first connecting board 130 at the position of the groove. The combining surface is metallurgically bonded, that is, the composited surface is formed by interdiffusion of atoms at the contact surface between the two metals. Recombination rate of the combining surface is usually not less than 90%, preferably 100%. Further, the tensile strength of the combining surface is preferably greater than the tensile strength of the first connecting board 130 and the first conductive board 120, so that the combining surface of the first connecting board 130 and the first conductive board 120 forms a stable electrical transmission surface and does not slide due to external vibration or shock, which results in fluctuation in contact resistance. Optionally, the first pole 110 passes through the cap plate 500, the bottom wall of the groove and the first conductive board 120. The first conductive board 120 surrounds the periphery of the first pole 110.

Optionally, in length direction, the groove is located between the first extension portion 131 and the second extension portion 132. The first extension portion 131 and the second extension portion 132 provide edges of the groove, which may position both sides of the first conductive board 120. The groove can increase the contact area between the first conductive board 120 and the first connecting board 130 to improve overcurrent capability. Embedded connection is adopted so that the surface of the first conductive board 120 does not protrude from the surface of the first connecting board 130. The first conductive board 120 is connected to the first pole 110 and is welded (during the implementation, other combination methods such as cold rolling, hot rolling, explosion combining or explosion rolling etc. may also be adopted) on the first connecting board 130 at the same time, so that the electrode assembly are electrically connected with the connecting plate 801 through the first pole 110, the first conductive board 120, and the first connecting board 130, so as to control the charging and discharging of the electrode assembly. In order to achieve better connection stability and electrical conductivity for the first pole 110, the first conductive board 120 and the first connecting board 130, the material thereof can be selected with reference to the above embodiments.

In the above embodiments, the groove means that the first connecting board 130 is not penetrated along height direction of the first connecting board 130. The groove may also be replaced by a through hole which is formed by penetration of the first connecting board 130 along height direction of the first connecting board 130, and in this case, it is generally necessary to seal the annular contact surface of the first connecting board 130 and the first conductive board 120, usually by welding.

The strength of the connection surface between the first conductive board 120 and the first connecting board 130 is usually lower than the strength of the first conductive board 120 or the first connecting board 130 itself. If the first conductive board 120 penetrates the entire first connecting board 130 in thickness direction, the entire connection surface is subjected to shear stress (for example, the connecting plate will have a force on the first connecting board 130 when the electrode assembly expands), which lead to a greater risk of fracture. When the groove is provided, a part of the shear stress is shared by the first connecting board 130, which reduces the risk of fracture at the connection surface. Since the groove is provided and the first conductive board 120 is embedded in the groove, the connection surface between the first connecting board 130 and the first conductive board 120 can be tightened to prevent the surface from fracturing during blanking.

Optionally, the first pole 110 is fixedly connected to the first connecting board 130 by riveting, which can not only prevent the end of the first pole 110 from loosening, but also further ensure stability of the connection surface between the first conductive board 120 and the first connecting board 130 to reduce the risk of fracture at the connection surface.

Optionally, the first pole 110 and the first conductive board 120 are connected by welding, which may reduce contact resistance between the first pole 110 and the first conductive board 120. Specifically, an edge of the first pole 110 is welded on the first conductive board 120, so that the sealing between the first pole 110 and the first conductive board 120 can be further ensured effectively, so as to prevent leak of the inside of the electrode assembly via the first pole 110.

Optionally, a step-like connection surface is formed between the first conductive board 120 and the first pole 110, and the upper surface of the first pole 110 is lower than the upper surface of the first conductive board 120, so that the surface of the first pole 110 would not be in contact with the strip-like connecting plate when the connecting plate 130 is connected to the first connecting board 130. As a result, good connection of the connecting plate can be ensured and bulge can be avoided.

Optionally, the first conductive board 120 extends in width direction and penetrates through the first connecting board 130. The width direction refers to a direction perpendicular to the length direction of the cap plate 500 on the surface of the cap plate 500. Due to the design of the first conductive board 120 penetrating the first connecting board 130, the groove is more easily formed, and also the first conductive board 120 is facilitated to be integrally formed on the first connecting board 130, and then the first connecting board 130 is cut. In this way, processing efficiency can be improved, processing cost is reduced, and the connection force between the first conductive board 120 and the first connecting board 130 is also improved.

Optionally, the upper surface of the first conductive board 120 is not higher than the upper surface of the first connecting board 130. In this way, the connecting plate will not contact with the first conductive board 120 when the connecting plate is connected with the first connecting board 130, and thus bulge is avoided, so that the connection between the first connecting board 130 and the connecting plate is more stable.

Optionally, the second electrode terminal 200 includes a second pole 210 and a second terminal board 230. The second pole 210 passes through the cap plate 500 and is connected to the second terminal board 230. The second terminal board 230 is located at a side of the cap plate 500 away from the first electrode terminal 100. In this embodiment, both the second pole 210 and the second terminal board 230 are made of aluminum or aluminum alloy, that is, the second terminal board 230 and the connecting plate are made of a same material. Based on the understanding of those skilled in the art, the second electrode terminal 200 may also be integrally formed on the cap plate 500 or a protruding structure may be directly formed on the cap plate 500 as the second electrode terminal 200.

### Embodiment 2 of the Present Disclosure

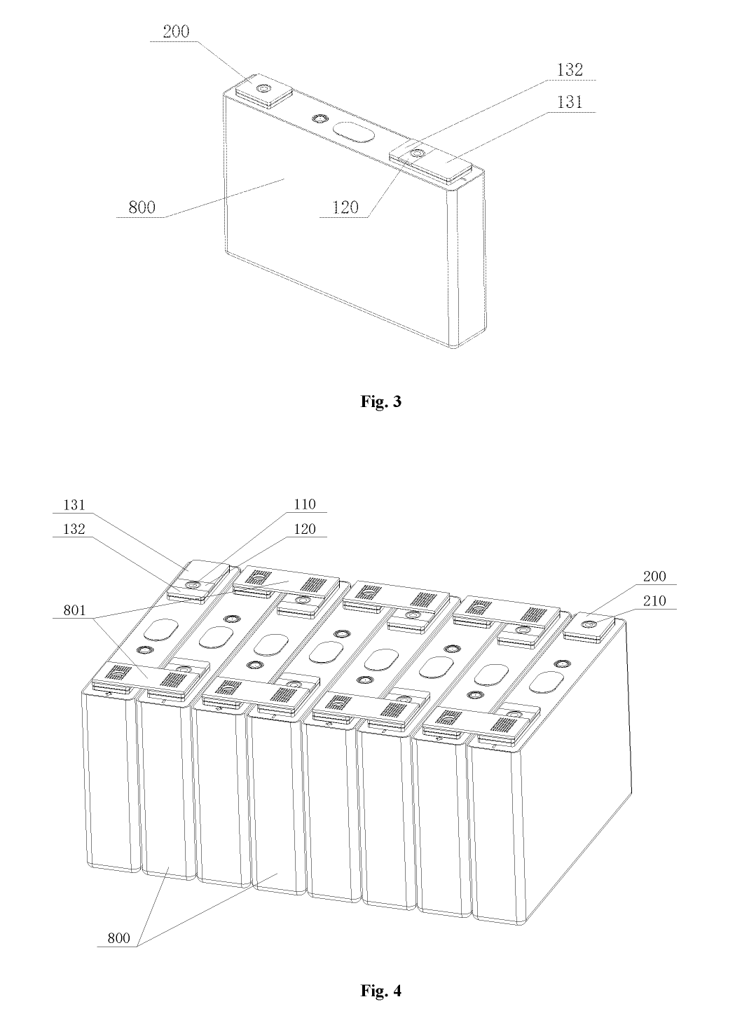

As shown in FIG. 2-FIG. 3, according to a second aspect of the embodiments of the present disclosure, there is further provided a power battery 800. The power battery 800 includes an electrode assembly 700, a shell and a cap assembly 600 for the power battery. The shell accommodates the electrode assembly 700. The cap assembly 600 for the power battery closes the opening of the shell. In the cap assembly 600 for the power battery provided by the Embodiment 1 of the present disclosure, structure of the first electrode terminal is optimized so that the connecting plate made of a single material can be welded well with the first electrode terminal and the second electrode terminal. In addition, when the power batteries are connected in series in thickness direction, the first extension portion and the second electrode terminal of two adjacent power batteries can be disposed in a same line without occupying the space between the first electrode terminal and the second electrode terminal. As a result, it can be avoided to use Z-shaped connecting plate and the arrangement of the module harness board will not be affected.

### Embodiment 3 of the Present Disclosure

As shown in FIG. 4, according to a third aspect of the embodiments of the present disclosure, there is further provided a battery module. The battery module includes two or more power batteries 800. For the power battery 800, the first connecting board 130 of the first electrode terminal 100 and the second terminal board 230 of the second electrode terminal 200 are made of a same material. The electrode terminals of two adjacent power batteries 800 are connected by the connecting plate 801 which is made of the same material as the first connecting board 130 and welded to the first extension portion 135 of one of the power batteries. The connecting plate 801 extends in width direction and connects to the second electrode terminal 200 of another power battery 800.

In the battery module provided by the embodiments of the present disclosure, structure of the first electrode terminal in the power battery is optimized so that the connecting plate made of a single material can be welded well with the first electrode terminal and the second electrode terminal. In addition, when the power batteries are connected in series in thickness direction, the first extension portion and the second electrode terminal of two adjacent power batteries can be disposed in a same line without occupying the space between the first electrode terminal and the second electrode terminal. As a result, it can be avoided to use Z-shaped connecting plate and the arrangement of the module harness board will not be affected.

Those skilled in the art should understand that the above embodiments are exemplary rather than limitative. Different technical features in different embodiments may be combined to obtain beneficial effects. Other variations of the described embodiments can be understood and practiced by those skilled in the art upon studying the drawings, the specification and the claims herein. In the claims, the term “comprising” does not exclude other means or steps; the indefinite article “a” does not exclude a plurality of; the terms “first”, “second” are used to illustrate names rather than to indicate any particular order. Any reference numerals in the claims should not be construed as limiting the scope of protection. The functions of the various parts in the claims may be implemented by a single hardware or software module. The presence of certain features in different dependent claims does not indicate that these technical features cannot be combined to achieve beneficial effects.

What is claimed is:

1. A cap assembly for a power battery, comprising:
a cap plate;
a first electrode terminal disposed at an end of the cap plate in length direction, wherein the first electrode terminal includes a first pole and a first terminal board, the first terminal board is located at a side of the cap plate in height direction and includes a first connecting board and a first conductive board, the first conductive board exposes from a side of the first connecting board away from the cap plate, and the first conductive board is connected with the first pole and the first connecting board; and
a second electrode terminal disposed at the other end of the cap plate in length direction,
wherein the first connecting board has a first extension portion extending in a direction away from the second electrode terminal and a second extension portion extending in a direction approaching the second electrode terminal, the first conductive board is located at a side of the first extension portion close to the second electrode terminal; length of the first extension portion is greater than that of the second extension portion in length direction, and wherein the first pole and the first conductive board are made of a same material, and the first extension portion is made of a different material.

2. The cap assembly for the power battery of claim 1, further comprising:
a transforming plate connected to the cap plate and opposite to the first extension portion, wherein when gas pressure inside the power battery reaches a threshold, the transforming plate is deformed and in contact with the first extension portion so as to cause electrical connection between the first electrode terminal and the second electrode terminal.

3. The cap assembly for the power battery of claim 1, wherein the second electrode terminal is electrically connected to the cap plate, and the first electrode terminal is insulated from the cap plate.

4. The cap assembly for the power battery of claim 1, wherein the first pole and the first conductive board are made of copper or copper alloy, and the first extension portion is made of aluminum or aluminum alloy.

5. The cap assembly for the power battery of claim 4, wherein the first extension portion and the second electrode terminal are made of a same material.

6. The cap assembly for the power battery of claim 1, wherein an opening is provided on a side of the first connecting board away from the cap plate, and the first conductive board is embedded in the opening.

7. The cap assembly for the power battery of claim 6, wherein the opening is a groove that does not penetrate through the first connecting board in height direction, or the opening is a through hole that penetrates through the first connecting board in height direction.

8. The cap assembly for the power battery of claim 7, wherein the groove is located between the first extension portion and the second extension portion in length direction.

9. The cap assembly for the power battery of claim 7, wherein the first pole passes through the cap plate, a bottom wall of the groove, and the first conductive board, and wherein the first conductive board surrounds periphery of the first pole.

10. The cap assembly for the power battery of claim 9, wherein the first pole is fixedly connected with the first connecting board by riveting.

11. The cap assembly for the power battery of claim 9, wherein the first pole and the first conductive board are connected by laser welding.

12. The cap assembly for the power battery of claim 7, wherein when the opening is a groove that does not penetrate through the first connecting board in height direction, the first conductive board extends in width direction and penetrates through the first connecting board.

13. The cap assembly for the power battery of claim 2, wherein projection length of the transforming plate projected in thickness direction is greater than length of the second extension portion.

14. A power battery comprising:
an electrode assembly;
a shell accommodating the electrode assembly; and
the cap assembly for the power battery of claim 1 which is used to close opening of the shell.

15. A battery module comprising:
two or more the power batteries of claim 14; and
a connecting plate which is made of a same material as the first extension portion, wherein the connecting plate is welded to the first extension portion of one of the power batteries.

16. The battery module of claim 15, wherein the connecting plate extends in width direction and connects with the second electrode terminal of another one of the power batteries.
